(19) United States
(12) Patent Application Publication
(10) Pub. No.: US 2025/0044785 A1
(43) Pub. Date: Feb. 6, 2025

(54) INFORMATION PROCESSING SYSTEM

(71) Applicant: NEC Corporation, Minato-ku, Tokyo (JP)

(72) Inventor: Masanao NATSUMEDA, Tokyo (JP)

(73) Assignee: NEC Corporation, Minato-ku, Tokyo (JP)

(21) Appl. No.: 18/718,516

(22) PCT Filed: Dec. 23, 2021
(86) PCT No.: PCT/JP2021/048035

§ 371 Date: Jun. 11, 2024

(51) Int. Cl. G05B 23/02

(52) U.S. Cl. CPC G05B 23/0283

(57) ABSTRACT

An information processing system predicts a condition of a device from time-series data acquired from the device, by using a trained model. When predicting, the information processing system allows the trained model to extract features that depend on the sequence from pieces of partial time-series data obtained by dividing the time-series data along the time axis, generate first vectors in which the extracted features are embedded, each of the first vectors corresponding to each of the pieces of the partial time-series data one to one, generate a second vector in which the first vectors are embedded, extract features that depend on the sequence from the first vectors, generate a third vector in which the extracted features are embedded, generate a fourth vector in which the second vector and the third vector are embedded, and transform the fourth vector into a first value that represents a condition of the device.

### TECHNICAL FIELD

The present invention relates to an information processing system and an information processing method for predicting a condition of a device from time-series data acquired from the device, and a storage medium.

### BACKGROUND ART

In order to realize predictive maintenance, it is necessary to quantitatively predict the degree of deterioration of a device. The degree of deterioration that is quantitatively predicted is called Remaining Useful Life (RUL). A method of predicting the remaining useful life from measured data that is time-series data by using machine learning has been proposed.

For example, first related art of the present invention is a technique of predicting the remaining useful life of a device by dividing time-series data, acquired from the device by a sensor, into a plurality of pieces of partial time-series data along the time axis, and inputting a feature value extracted for each piece of the partial time-series data into a recurrent neural network (for example, Patent Literature 1).

Second related art of the present invention is a technique of predicting the remaining useful life of a device by acquiring, for each piece of time-series data having a predetermined time length acquired from the device by a sensor, various statistical values such as an effective value, a maximum value, a peak factor, a kurtosis, and a skewness from the time-series data, and generating a feature vector to predict the remaining useful life from the feature vector (for example, Patent Literature 2).

### CITATION LIST

### Patent Literature

Patent Literature 1: JP 2020-198081 A
Patent Literature 2: JP 2021-056153 A
Patent Literature 3: US 2021/0232917 A1
NON-PATENT LITERATURE

Non-Patent Literature 1: Masanao Natsumeda, Haifeng Chen, “RULENet: End-to-end Learning With the Dual-estimator for Remaining Useful Life Estimation”, 2020 IEEE International Conference on Prognostics and Health Management (ICPHM), Jun. 8-10, 2020

### SUMMARY OF INVENTION

### Technical Problem

A feature value indicating the remaining useful life may appear in various forms in time-series data acquired by a sensor. For example, a feature value indicating the remaining useful life may appear as a long-term gradual tendency of the time-series data. Moreover, a feature value indicating the remaining useful life may appear as a short-term change in the time-series data. Therefore, since there is a case where it is difficult to specify information necessary for predicting the remaining useful life, in the first and second related art of the present invention, the remaining useful life may not be predictable with high accuracy. A similar problem may be caused in the case of predicting a condition other than the remaining useful life of a device (for example, presence or absence of abnormality, failure diagnosis, deterioration state, and the like).

An object of the present invention is to provide an information processing system, an information processing method, and a storage medium that solve the above-described problems.

### Solution to Problem

An information processing system, according to one aspect of the present invention, is configured to include
a learning unit configured to generate a trained model that predicts a condition of a device from time-series data acquired from the device.

The trained model is configured to includes
a first component that extracts features that depend on the sequence from a plurality of pieces of partial time-series data obtained by dividing the time-series data along the time axis, and generates a plurality of first vectors in which the extracted features are embedded, each of the first vectors corresponding to each of the pieces of the partial time-series data one to one;
a second component that generates a second vector in which the first vectors are embedded;
a third component that extracts features that depend on sequence from the first vectors, and generates a third vector in which the extracted features are embedded;
a fourth component that generates a fourth vector in which the second vector and the third vector are embedded; and
a fifth component that transforms the fourth vector into a first value that represents a condition of the device.

An information processing system, according to another aspect of the present invention, is configured to include
a prediction unit configured to predict a condition of a device from time-series data acquired from the device by using a trained model.

The trained model is configured to includes
a first component that extracts features that depend on the sequence from a plurality of pieces of partial time-series data obtained by dividing the time-series data along the time axis, and generates a plurality of first vectors in which the extracted features are embedded, each of the first vectors corresponding to each of the pieces of the partial time-series data one to one;
a second component that generates a second vector in which the first vectors are embedded;
a third component that extracts features that depend on sequence from the first vectors, and generates a third vector in which the extracted features are embedded;
a fourth component that generates a fourth vector in which the second vector and the third vector are embedded; and
a fifth component that transforms the fourth vector into a first value that represents a condition of the device.

An information processing method, according to another aspect of the present invention, is configured to include
predicting a condition of a device from time-series data acquired from the device by using a trained model.

The prediction includes allowing the trained model to
extract features that depend on the sequence from a plurality of pieces of partial time-series data obtained by dividing the time-series data along the time axis;
generate a plurality of first vectors in which the extracted features are embedded, each of the first vectors corresponding to each of the pieces of the partial time-series data one to one;
generate a second vector in which the first vectors are embedded;
extract features that depend on sequence from the first vectors;
generate a third vector in which the extracted features are embedded;
generate a fourth vector in which the second vector and the third vector are embedded; and
transform the fourth vector into a first value that represents a condition of the device.

An information processing method, according to another aspect of the present invention, is configured to include
generating a trained model that predicts a condition of a device from time-series data acquired from the device.

The generation includes allowing the trained model to:
extract features that depend on the sequence from a plurality of pieces of partial time-series data obtained by dividing the time-series data along the time axis;
generate a plurality of first vectors in which the extracted features are embedded, each of the first vectors corresponding to each of the pieces of the partial time-series data one to one;
generate a second vector in which the first vectors are embedded;
extract features that depend on sequence from the first vectors;
generate a third vector in which the extracted features are embedded;
generate a fourth vector in which the second vector and the third vector are embedded; and
transform the fourth vector into a first value that represents a condition of the device.

A computer-readable medium, according to another aspect of the present invention, is configured to store thereon a program for causing a computer to execute processing to generate a trained model that predicts a condition of a device from time-series data acquired from the device.

The generation includes allowing the trained model to:
extract features that depend on the sequence from a plurality of pieces of partial time-series data obtained by dividing the time-series data along the time axis;
generate a plurality of first vectors in which the extracted features are embedded, each of the first vectors corresponding to each of the pieces of the partial time-series data one to one;
generate a second vector in which the first vectors are embedded;
extract features that depend on sequence from the first vectors;
generate a third vector in which the extracted features are embedded;
generate a fourth vector in which the second vector and the third vector are embedded; and
transform the fourth vector into a first value that represents a condition of the device.

A computer-readable medium, according to another aspect of the present invention, is configured to store thereon a program for causing a computer to execute processing to predict a condition of a device from time-series data acquired from the device by using a trained model.

The prediction includes allowing the trained model to
extract features that depend on the sequence from a plurality of pieces of partial time-series data obtained by dividing the time-series data along the time axis;
generate a plurality of first vectors in which the extracted features are embedded, each of the first vectors corresponding to each of the pieces of the partial time-series data one to one;
generate a second vector in which the first vectors are embedded;
extract features that depend on sequence from the first vectors;
generate a third vector in which the extracted features are embedded;
generate a fourth vector in which the second vector and the third vector are embedded; and
transform the fourth vector into a first value that represents a condition of the device.

### Advantageous Effects of Invention

With the configurations as described above, the present invention is capable of predicting a condition of a device with high accuracy from time-series data acquired from the device.

### BRIEF DESCRIPTION OF DRAWINGS

FIG. 1 is a block diagram of an information processing device according to a first example embodiment of the present invention.

FIG. 2 is a flowchart illustrating an example of an operation in a learning phase of the information processing device according to the first example embodiment of the present invention.

FIG. 3 is a flowchart illustrating an example of an operation in a prediction phase of the information processing device according to the first example embodiment of the present invention.

FIG. 4 is a configuration diagram illustrating an example of a model used in the first example embodiment of the present invention.

FIG. 5 illustrates examples of a function of calculating a weighted sum and a function of giving a weight used in the first example embodiment of the present invention.

FIG. 6 is a flowchart illustrating details of a process of generating a trained model by using multivariate time-series data for learning in the first example embodiment of the present invention.

FIG. 7 is a flowchart illustrating details of a process of estimating the remaining useful life of a device by using a trained model in the first example embodiment of the present invention.

FIG. 8 is a configuration diagram illustrating an example of a model used in a second example embodiment of the present invention.

FIG. 9 is a configuration diagram illustrating an example of a model used in a third example embodiment of the present invention.

FIG. 10 is a block diagram illustrating an example of a dual prediction model used in a fourth example embodiment of the present invention.

FIG. 11 is a block diagram of an information processing system according to a seventh example embodiment of the present invention.

FIG. 12 is a block diagram of an information processing system according to an eighth example embodiment of the present invention.

### DESCRIPTION OF EMBODIMENTS

Next, example embodiments of the present invention will be described in detail with reference to the drawings.

### First Example Embodiment

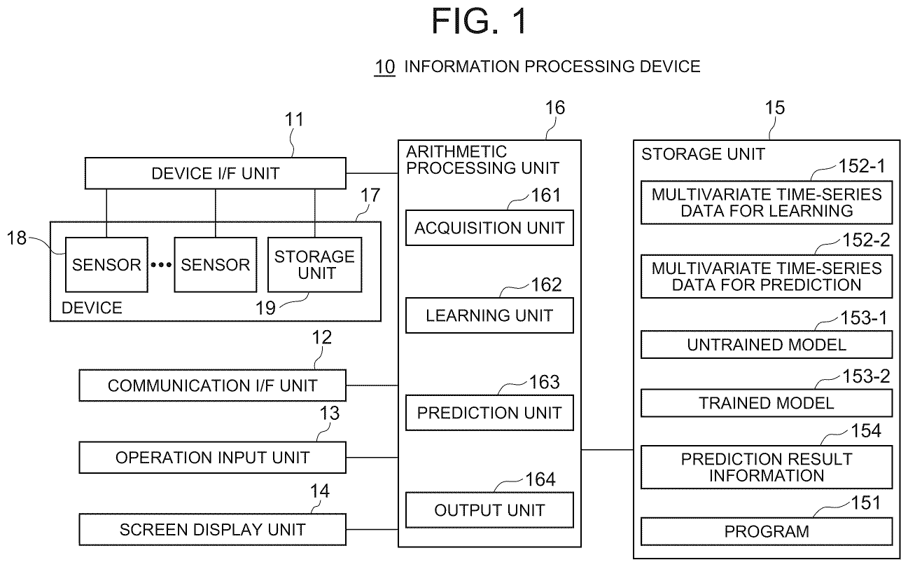

FIG. 1 is a block diagram of an information processing device 10 according to a first example embodiment of the present invention. The information processing device 10 is a device that predicts the remaining useful life of a device 17 from a plurality of pieces of time-series data collected from the device 17. However, the present invention may predict the remaining useful life of the device from single time-series data collected from the device 17.

Referring to FIG. 1, the information processing device 10 includes a device interface (I/F) unit 11, a communication I/F unit 12, an operation input unit 13, a screen display unit 14, a storage unit 15, and an arithmetic processing unit 16.

The device I/F unit 11 is connected with the device 17 in a wired or wireless manner. The device 17 is an industrial device whose remaining useful life is to be predicted. The device 17 may be of any type. The device 17 is provided with one or more sensors 18. The type and the number of the sensors 18 are not limited. For example, the sensor 18 may be a sensor that measures vibration generated in response to the operation of the device 17. The sensor 18 may be a sensor that measures the temperature of the device 17. The sensor 18 may be a sensor of a type other than those mentioned above, that is, a humidity sensor, a pressure sensor, a flow rate sensor, an acceleration sensor, a displacement sensor, an electric power sensor, an electric flow sensor, an acoustic sensor, or the like, for example. Measurement by the sensor 18 may be performed at predetermined time intervals, rather than constant measurement. The device I/F unit 11 acquires time-series measurement values measured constantly or measured periodically at the same timing by at least one sensor 18, and transmits them to the arithmetic processing unit 16.

The communication I/F unit 12 is configured of a data communication circuit, and performs data communication with an external device, not illustrated, in a wired or wireless manner. The operation input unit 13 is configured of operation input devices such as a keyboard and a mouse, and detects operation by an operator and outputs it to the arithmetic processing unit 16. The screen display unit 14 is configured of a screen display device such as a liquid crystal display (LCD), and displays various types of information such as a prediction result according to an instruction from the arithmetic processing unit 16.

The storage unit 15 is configured of one or more storage devices such as a hard disk and a memory, and stores therein processing information necessary for various types of processing in the arithmetic processing unit 16 and a program 151. The program 151 is a program for implementing various processing units by being read and executed by the arithmetic processing unit 16, and is read in advance from an external device or a storage medium via a data input/output function of the communication I/F unit 12 or the like and is stored in the storage unit 15. The main processing information stored in the storage unit 15 includes multivariate time-series data 152-1 for learning, multivariate time-series data 152-2 for prediction, an untrained model 153-1, a trained model 153-2, and prediction result information 154.

The multivariate time-series data 152-1 for learning and the multivariate time-series data 152-2 for prediction include time-series data of measurement values for each sensor acquired from at least one device 17. In the below description, it is assumed that multivariate time-series data is configured of n pieces (n represents positive integer of 2 or larger) of time-series data. The multivariate time-series data 152-1 for learning is previously created on the basis of data from the point of time when the devices 17 are in a sound state until a point of time when a failure occurs (also called as Run-To-Failure data). The multivariate time-series data 152-1 for learning may be data from a point of time when the devices 17 are in a sound state until a point of time when a failure occurs, and may be data from immediately after the maintenance until immediately before the maintenance. In general, there are a plurality of pieces of multivariate time-series data 152-1 for learning. Each piece of multivariate time-series data 152-1 for learning further includes correct data. Correct data is data indicating a correct answer of a prediction result of the remaining useful life using the multivariate time-series data 152-1 for learning. On the other hand, the multivariate time-series data 152-2 for prediction is data from a pint of time when the device 17 subject to prediction is in a sound state until the prediction point.

Both the untrained model 153-1 and the trained model 153-2 are machine learning models. In the untrained model 153-1, parameters such as a weight is learned so as to predict the remaining useful life of the device 17 from the multivariate time-series data by using the multivariate time-series data 152-1 for learning. When the parameters are learned, the untrained model 153-1 is stored as the trained model 153-2. The trained model 153-2 is used to predict the remaining useful life of the device 17 subject to prediction, by using the multivariate time-series data 152-2 for prediction.

The prediction result information 154 is information representing a result of prediction from the multivariate time-series data 152 for prediction by using the trained model 153-2. The prediction result information 154 includes the remaining useful life of the device 17. The remaining useful life represents the remaining useful life of the device 17 at the end time of the input multivariate time-series data.

The arithmetic processing unit 16 has at least one processor such as an MPU and peripheral circuits thereof, and reads the program 151 from the storage unit 15 and executes it to allow the hardware and the program 151 to cooperate with each other to thereby implement various processing units. The main processing units implemented by the arithmetic processing unit 16 include an acquisition unit 161, a learning unit 162, a prediction unit 163, and an output unit 164.

The acquisition unit 161 acquires time-series data of measurement values of a plurality of sensors 18 mounted on at least one device 17 via the device I/F unit 11 or/and the communication I/F unit 12, and stores it in the storage unit 15 as the multivariate time-series data 152-1 for learning or the multivariate time-series data 152-2 for prediction.

The learning unit 162 uses the multivariate time-series data 152-1 for learning to allow the untrained model 153-1 to perform machine learning so as to predict the remaining useful life of a device from the multivariate time-series data. Then, the learning unit 162 stores the model 153-1 subjected to machine learning in the storage unit 15 as the trained model 153-2. That is, the learning unit 162 generates the trained model 153-2 to predict the remaining useful life of the device 17 from the multivariate time-series data 152-2 for prediction.

The prediction unit 163 uses the trained model 153-2 to predict the remaining useful life of the device 17 from the multivariate time-series data 152-2 for prediction acquired from the device 17. The prediction unit 163 stores the prediction result information 154 including the predicted remaining useful life of the device 17 in the storage unit 15.

The output unit 164 reads, from the storage unit 15, the prediction result information 154 including the remaining useful life of the device 17 predicted by the prediction unit 163, and displays it on the screen display unit 14 or/and transmits it to an external device via the communication I/F unit 12.

Next, operation of the information processing device 10 will be described. Operation of the information processing device 10 is largely divided into a learning phase and a prediction phase. The learning phase is a phase in which the untrained model 153-1 performs machine-learning, and the trained model 153-2 is generated. The prediction phase is a phase in which the remaining useful life of the device 17 is predicted by using the trained model 153-2, and the result is output.

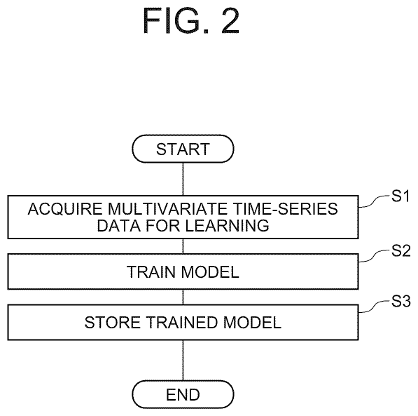

FIG. 2 is a flowchart illustrating an example of operation in the learning phase. Referring to FIG. 2, first, the acquisition unit 161 acquires the multivariate time-series data 152-1 for learning from an external device via the communication I/F unit 12 for example, and stores it in the storage unit 15 (step S1). Then, the learning unit 162 allows the untrained model 153-1 to perform machine learning using the multivariate time-series data 152-1 for learning, and generates the trained model 153-2 (step S2). Then, the learning unit 162 stores the trained model 153-2 in the storage unit 15 (step S3).

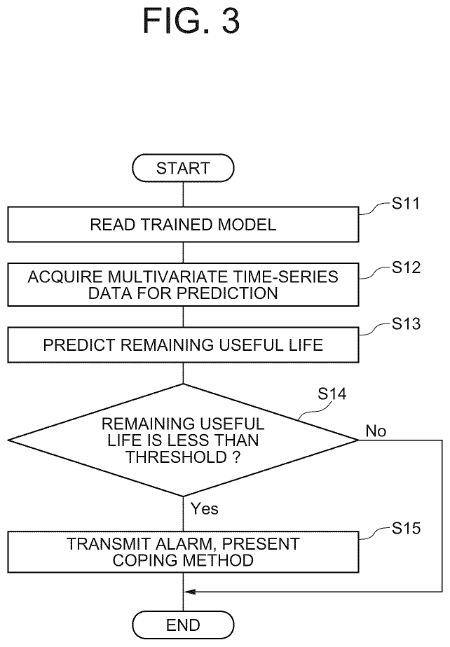

FIG. 3 is a flowchart illustrating an example of operation in the prediction phase. Referring to FIG. 3, first, the prediction unit 163 reads the trained model 153-2 from the storage unit 15 (step S11). Then, the acquisition unit 161 acquires the multivariate time-series data 152-2 for prediction from the device 17 subject to prediction via the device I/F unit 11 for example, and stores it in the storage unit 15 (step S12). Then, by using the trained model 153-2, the prediction unit 163 predicts the remaining useful life of the device 17 from the multivariate time-series data 152-2 for prediction, and stores the prediction result information 154 including the remaining useful life in the storage unit 15 (step S13). Then, the output unit 164 reads the prediction result information 154 from the storage unit 15, and determines whether or not the remaining useful life is less than a preset threshold (step S14). When the remaining useful life is less than the threshold, the output unit 164 displays an alarm and a predetermined coping method on the screen display unit 14, or/and transmit it to an external device via the communication I/F unit 12 (step S15). The predetermined coping method may include instructions for maintenance or replacement of the device 17, for example.

Next, configuration and operation of each unit of the information processing device 10 will be described in detail.

First, configuration examples of the untrained model 153-1 and the trained model 153-2 will be described in detail. Hereinafter, when the untrained model 153-1 and the trained model 153-2 are not particularly distinguished from each other, they are simply referred to as a model 153. Further, when the multivariate time-series data 152-1 for learning and the multivariate time-series data 152-2 for prediction are not particularly distinguished from each other, they are simply referred to as multivariate time-series data 152.

The features of information indicating the remaining useful life that appears in the time-series data of measurement values of a sensor are largely classified into two features as described below. One is a feature appearing as a long-term gradual tendency of the time-series data. Such a feature is referred to as a long-term feature herein. For example, rising/falling trend of measurement values of a specific sensor (for example, temperature sensor) is an example of a long-term feature. The other one is a feature appearing as a short-term change in the time-series data. Such a feature is referred to as a short-term feature herein. For example, a short-term sharp fluctuation in the measurement data of a sensor, a sudden drop or rise of measurement data in a short term, and the like are examples of the short-term feature. The model 153 is trained to extract such a long-term feature and a short-term feature separately from the time-series data, and predict the remaining useful life on the basis thereof.

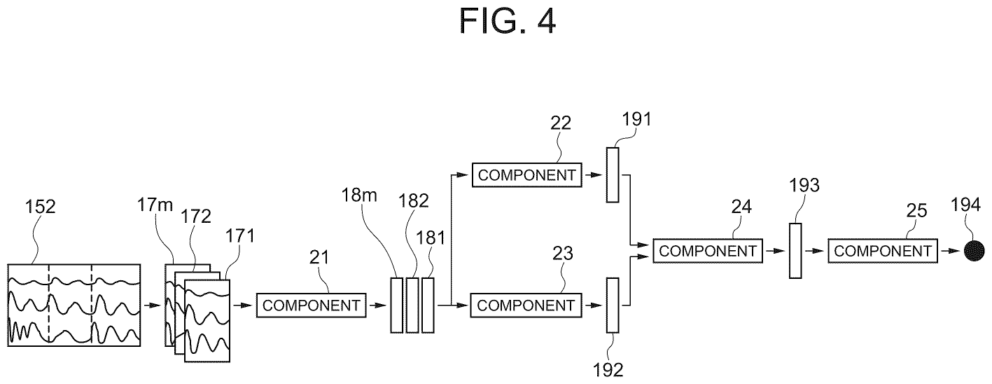

FIG. 4 is a configuration diagram illustrating an example of the model 153. The model 153 of this example is configured of five components 21 to 25.

The component 21 inputs thereto m pieces (m is positive integer of 2 or larger) of partial multivariate time-series data 171 to 17m obtained by dividing the multivariate time-series data 152 into m pieces along the time axis, from the outside of the model 153. The multivariate time-series data 152 includes n pieces of time-series data. Accordingly, one piece of partial multivariate time-series data 15i (i=1, . . . , m) includes n pieces of partial time-series data.

Division of the multivariate time-series data 152 may be applied with any of the methods provided below as examples.
(a) Divide at equal intervals.
(b) When the device 17 performs repeated operation, divide by one cycle of the repeated operation, or further divide a section of one cycle, divided when repeated operation is performed, into a plurality of parts at equal intervals.
(c) Length of all pieces of partial multivariate time-series data 171 to 17m after the division may not be the same (partial multivariate time-series data having different length may be included).
(d) Any duplication is acceptable in the divided pieces of partial multivariate time-series data 171 to 17m. However, in the component 23 in the latter stage of the model 153, since a dependent relation in the time direction between column vectors is learned, it is preferable that there is no duplication in order to reduce the calculation amount.
(e) A plurality of pieces of partial multivariate time-series data 171 to 17m may be extracted from a part of the multivariate time-series data 152. For example, in the case of dividing at equal intervals for convenience, the remainder may be omitted.
(f) One obtained by applying a padding process to the multivariate time-series data 152 may be subject to division. For example, in the case of dividing at equal intervals for convenience, in order not to generate remainder, a value immediately before or immediately after may be added to before or after the multivariate time-series data 152 before division.
(g) A plurality of pieces of partial multivariate time-series data 171 to 17m, obtained by division beforehand, may be input.
(h) The multivariate time-series data 152 may be one applied with signal processing. For example, not only time region information that is a measurement value in the multivariate time-series data 152 but also frequency region information obtained by applying Fourier transform to the time region information or quefrency region information obtained by further applying Fourier transform to the frequency region information may be subject to division.

From each partial time-series data of the m pieces of partial multivariate time-series data 171 to 17m, the component 21 extracts various features that depend on the sequence (order) of the pieces of data constituting the partial time-series data. The features that depend on the sequence include the following features, but are not limited thereto.
(a) Statistical amount of a difference between preceding data and subsequent data (average, dispersion, maximum value, minimum value, and the like
(b) Values obtained by calculus (inclination, area, and the like)
(c) Peak detection values (the number of peaks, the height of peak, and the like)
(d) Frequency component obtained by Fourier transform or the like
(e) Pattern as a waveform

The features that depend on the sequence may become different features when the time-series data is reordered. For example, between time-series data (D1, D2, D3) and reordered time-series data (D2, D1, D3), the features that depend on the sequence are different

However, the features extracted by the component 21 are not limited to the features that depend on the sequence. The component 21 may further extract features that do not depend on the sequence from each piece of time-series data of each of the m pieces of partial multivariate time-series data 171 to 17m. Examples of features that do not depend on the sequence include the following features, but are not limited thereto.
(f) Statistical amount (average, dispersion, maximum value, minimum value, and the like)

Since the features extracted by the component 21 are features extracted from respective pieces of partial multivariate time-series data 171 to 17m obtained by dividing the multivariate time-series data 152 into a plurality of pieces along the time axis, they are short-term features. Short-term features of the same type, extracted from different pieces of partial multivariate time-series data, are managed in association with time information of the partial multivariate time-series data of the extraction source.

The component 21 also generates column vectors 181 to 18m from the extracted short-term features. That is, the component 21 generates column vectors 181 to 18m in which the extracted short-term features are embedded. The column vectors 181 to 18m correspond to the partial multivariate time-series data 171 to 17m one to one. For example, the component 21 generates a column vector in which each short-term feature extracted from one piece of partial multivariate time-series data forms one vector element.

The component 21 having the functions described above may be realized through learning of a neural network such as a recurrent neural network (RNN, LSTM, GRU, or the like), CNN, Transformer, or the like. The trained component 21 inputs thereto m pieces of partial multivariate time-series data 171 to 17m constituting the multivariate time-series data 152, and from each piece of partial time-series data in each piece of the partial multivariate time-series data, extracts a short-term feature that is effective for a task (in the present example, prediction of remaining useful life). Then, the component 21 generates and outputs the column vectors 181 to 18m in which the extracted short-term features are embedded. The neural network extracts features by performing nonlinear transformation on the input data. Therefore, it can be said that the component 21 configured of a neural network extracts short-term features by applying non-linear transform that depends on the sequence to the input time-series data.

The component 22 inputs thereto the column vectors 181 to 18m from the component 21, and generates and outputs an intermediate vector 191 in which all of the column vectors 181 to 18m are embedded. For example, the component 22 may generate a weighted sum of the column vectors 181 to 18m as the intermediate vector 191.

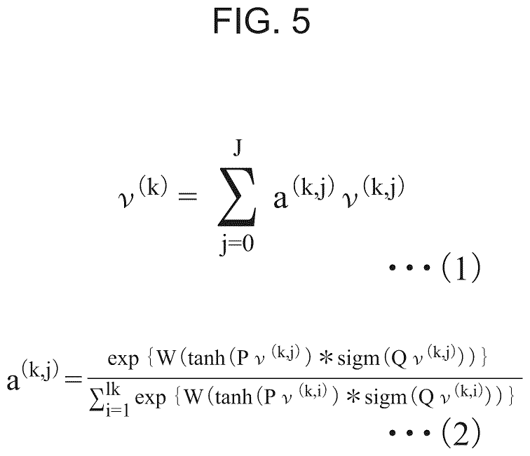

An example of a function of calculating a weighted sum v^{(k)} of the column vectors 181 to 18m by the component 22 is illustrated as Expression 1 in FIG. 5. In Expression 1, k represents the number of the source time-series data 152, J represents the number of input column vectors, v^{(k,j)} represents a column vector, and a^{(k,j)} represents a weight of the column vector v^{(k,j)}. The weight a^{(k,j)} may be a function whose value is determined depending on the column vector v_{(k,j)}.

A n example of a function that gives the weight a^{(k,j)} is illustrated as Expression 2 in FIG. 5. In Expression 2, lₖ represents the number of input column vectors,*represents multiplication for each element, and sigm( ) represents a Sigmoid function. Further, W, P, and Q are parameters optimized through learning, where W represents a vector and P and Q represent matrix. The dimensions of W, P and Q are determined to so as give a scalar value as a^{(k,j)}.

However, the intermediate vector 191 is not limited to the weighted sum of the column vectors 181 to 18m. The intermediate vector 191 may be the sum, a weighted average, or an average of the column vectors 181 to 18m.

In this way, all of the column vectors 181 to 18m are embedded in the intermediate vector 191. As described above, in each column vector, a short-term feature extracted from the corresponding partial multivariate time-series data is embedded. This means that various short-term features extracted from the source multivariate time-series data are embedded in the intermediate vector 191. The weighted sum described above or the like is linear transform. Therefore, it can be said that the component 22 generates the intermediate vector 191 by applying linear transform not depending on the sequence to the column vectors 181 to 18m.

The component 23 inputs thereto the column vectors 181 to 18m from the component 21, and generates and outputs an intermediate vector 192. Specifically, the component 23 reorders the input column vectors 181 to 18m according to the acquired time of the corresponding partial multivariate time-series data 171 to 17m. Then, the component 23 extracts features that depend on the sequence (order) of the column vectors, from the reordered column vectors 181 to 18m. As described above, in the column vectors 181 to 18m, short-term features according to the respective acquired time are embedded. Therefore, the features extracted by the component 23 are features that appear as a gradual tendency in a long term of the short-term features, that is, long-term features.

The component 23 also generates an intermediate vector 192 from the extracted long-term features. That is, the component 23 generates the intermediate vector 192 in which the extracted long-term features are embedded.

The component 23 having the function as described above may be realized through learning of a neural network such as a recurrent neural network (RNN, LSTM, GRU, or the like), CNN, Transformer, or the like. The trained components 23 inputs thereto the column vectors 181 to 18m, and extracts long-term features that are effective for the task (in the present example, prediction of remaining useful life). Then, the component 23 generates and outputs the intermediate vector 192 in which the extracted long-term features are embedded. It can be said that the component 23 configured of a neural network extracts long-term features by applying non-linear transform that depends on the sequence to the time-series of the input column vectors.

The component 24 inputs thereto the intermediate vector 191 from the component 22, and inputs thereto the intermediate vector 192 from the component 23. Then, the component 24 generates and outputs a feature vector 193 in which the intermediate vector 191 and the intermediate vector 192 are embedded. For example, the component 24 may generate a vector by connecting the intermediate vector 191 and the intermediate vector 192, as the feature vector 193. Alternatively, the component 24 may generate the sum of the intermediate vector 191 and the intermediate vector 192 or a weighted sum calculated by the same method as that used for the component 22, as the feature vector 193.

As described above, in the intermediate vector 191, various short-term features extracted from the multivariate time-series data are embedded. Moreover, as described above, in the intermediate vector 192, various long-term features extracted from the multivariate time-series data are embedded. Therefore, in the feature vector 193 in which the intermediate vectors 191 and 192 are embedded, various short-term features and long-term features are embedded.

The component 25 inputs thereto the feature vector 193 from the component 24, and outputs a scalar value 194 indicating the remaining useful life. The component 25 may be realized through learning of a neural network (for example, multilayer Perceptron) for transforming a vector into a scalar value. The component 25 after the learning inputs thereto the feature vector 193, and outputs the scalar value 194 indicating the remaining useful life. In the feature vector 193, various short-term features and long-term features are embedded. Therefore, the component 25 outputs the scalar value 194 indicating the remaining useful life on the basis of the various short-term features and long-term features.

Next, details of step S2 in FIG. 2 executed by the learning unit 162, that is, details of a process of generating the trained model 153-2 by using the multivariate time-series data 152-1 for learning, will be described.

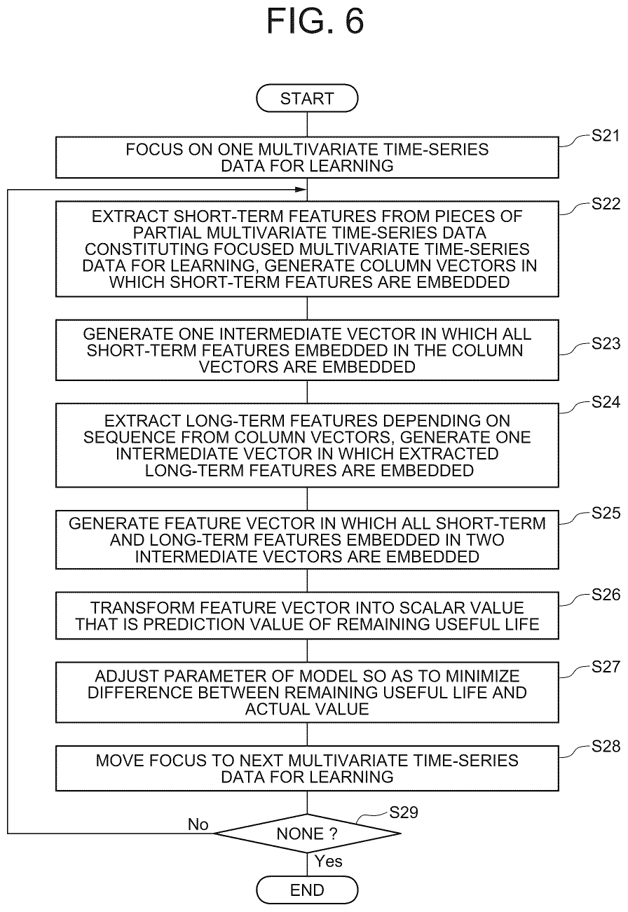

FIG. 6 is a flowchart illustrating an example of detailed processing of step S2. Referring to FIG. 6, the learning unit 162 focuses on one piece of the multivariate time-series data 152-1 for learning (step S21). Then, the learning unit 162 uses the component 21 to extract short-term features from a plurality of pieces of the partial multivariate time-series data 171 to 17m constituting the focused multivariate time-series data for learning, and generates a plurality of column vectors 181 to 18m in which the short-term features are embedded (step S22). Then, the learning unit 162 uses the component 22 to generate one intermediate vector 191 in which all short-term features embedded in the column vectors 181 to 18m are embedded (step S23). Then, the learning unit 162 uses the component 23 to extract long-term features that depend on the sequence from the column vectors 181 to 18m, and generate one intermediate vector 192 in which the extracted long-term features are embedded (step S24). Then, the learning unit 162 uses the component 24 to generate the feature vector 193 in which all short-term features and long-term features, embedded in the two intermediate vectors 191 and 192, are embedded (step S25). Then, the learning unit 162 uses the component 25 to transform the feature vector 193 into the scalar value 194 indicating the remaining useful life of the device (step S26). Then, the learning unit 162 adjusts the parameter of the model 153 so as to minimize the difference between the prediction value of the remaining useful life and the actual value of the remaining useful life given by the correct data included in the focused multivariate time-series data 152-1 for learning (step S27).

Then, the learning unit 162 moves the focus to the next multivariate time-series data 152-1 for learning (steps S28, S29), and returns to step S22 and repeats the same processing as that described above by using the newly focused multivariate time-series data 152-1 for learning. Then, upon completion of focusing on every multivariate time-series data 152-1 for learning (Yes at step S29), the learning unit 162 ends the processing of FIG. 6.

Next, details of step S13 in FIG. 3 executed by the prediction unit 163, that is, details of a process of predicting the remaining useful life of the device from the multivariate time-series data 152-2 for prediction by using the learned model 153-2, will be described.

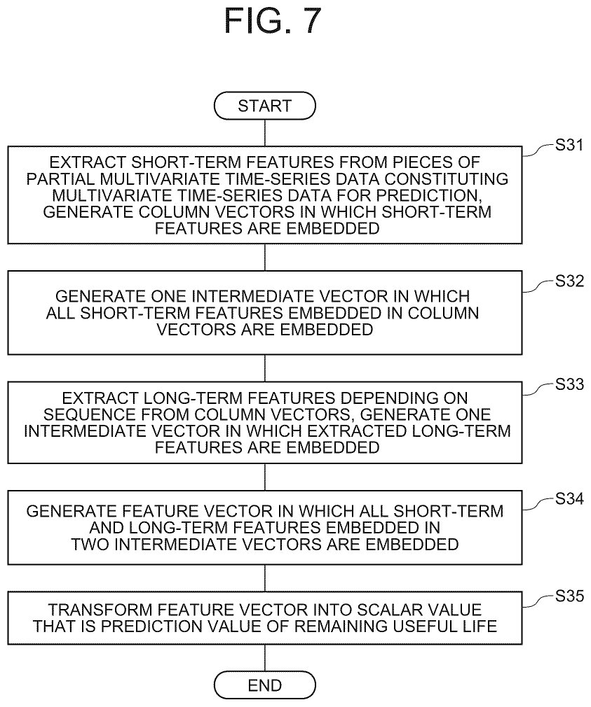

FIG. 7 is a flowchart illustrating an example of detailed processing of step S13. Referring to FIG. 7, the prediction unit 163 uses the component 21 to extract short-term features from a plurality of pieces of partial multivariate time-series data 171 to 17m constituting the multivariate time-series data 152-2 for prediction, and generates the column vectors 181 to 18m in which the short-term features are embedded (step S31). Then, the prediction unit 163 uses the component 22 to generate one intermediate vector 191 in which all short-term features, embedded in the column vectors 181 to 18m, are embedded (step S32). Then, the prediction unit 163 uses the component 23 to extract long-term features that depend on the sequence from the column vectors 181 to 18m, and generate one intermediate vector 192 in which the extracted long-term features are embedded (step S33). Then, the prediction unit 163 uses the component 24 to generate the feature vector 193 in which all short-term features and long-term features, embedded in the two intermediate vectors 191 and 192, are embedded (step S34). Then, the prediction unit 163 uses the component 25 to transform the feature vector 193 into the scalar value 194 indicating the remaining useful life of the device (step S35).

As described above, the information processing device 10 according to the present embodiment includes the learning unit 162 that generates the trained model 153-2 that predicts the remaining useful life of the device 17 from the multivariate time-series data acquired from the device 17. The trained model 153-2 includes the components 21 to 25. The component 21 extracts short-term features that are features depending on the sequence with respect to the respective pieces of the partial multivariate time-series data 171 to 17m obtained by dividing the multivariate time-series data 152 along the time axis, and generates the column vectors 181 to 18m in which the short-term features are embedded. The component 22 generate one intermediate vector 191 in which all short-term features, embedded in the column vectors 181 to 18m, are embedded. The component 23 extracts long-term features that are features depending on the sequence from the column vectors 181 to 18m, and generates one intermediate vector 192 in which the long-term features are embedded. The component 24 generates the feature vector 193 in which all short-term features and long-term features, embedded in the intermediate vectors 191 and 192, are embedded. The component 25 generates and outputs the scalar value 194 indicating the remaining useful life of the device 17 from the feature vector 193. Therefore, the information processing device 10 can predict the remaining useful life of the device 17 with higher accuracy compared with the case of using only the long-term features or only the short-term features.

Further, the route from input to output of the model 153 includes a first route via the component 22 and a second route via the component 23. The first route is a route of the case where short-term features are important for prediction of the remaining useful life. On the other hand, the second route is a route of the case where long-term features are important for prediction of the remaining useful life. Since there are routes for effective learning according to the feature as described above, learning can progress effectively, and it is possible to efficiently learn features effective for prediction of the remaining useful life. As a result, the prediction accuracy of the remaining useful life of the device 17 can be improved.

Next, other example embodiments of the present invention will be described.

### Second Example Embodiment

As compared with the first example embodiment, the present embodiment is similar to the first example embodiment except for the configuration of the model 153.

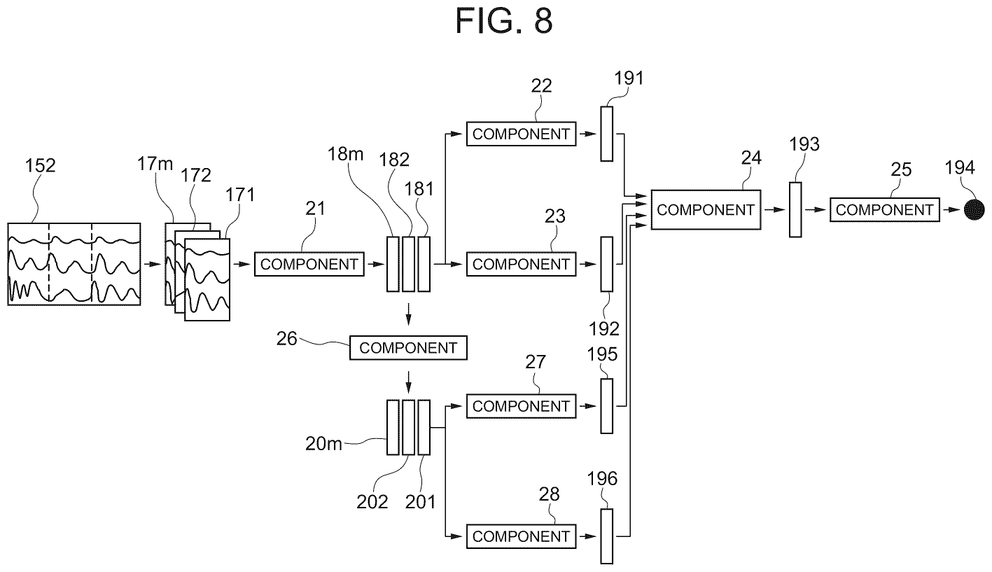

FIG. 8 is a configuration diagram illustrating an example of a model 153 used in the present embodiment. As compared with the model 153 illustrated in FIG. 4, the model 153 of this example is similar to the model 153 illustrated in FIG. 4 except that the model 153 of this example further includes components 26 to 28.

The component 26 inputs thereto the column vectors 181 to 18m from the component 21, and generates and outputs difference vectors 201 to 20m that correspond to the column vectors 181 to 18m one to one. Generation of the difference vectors are carried out as described below. First, the component 26 calculate an average vector of all column vectors 181 to 18m. As described above, in the column vectors 181 to 18m, the short-term features extracted from the partial multivariate time-series data 171 to 17m are embedded. Accordingly, it can be said that the average vector is an average of the short-term features. Then, for each column vector, the component 26 calculates a difference between the column vector and the average vector, and generates a difference vector. Accordingly, a difference vector represents a difference from an average of the short-term features extracted from the partial multivariate time-series data 171 to 17m.

The component 27 inputs thereto difference vectors 201 to 20m from the component 26, and generates and outputs an intermediate vector 195 in which all of the difference vectors are embedded. For example, the component 27 may generate a weighted sum of the difference vectors 201 to 20m as the intermediate vector 195. The method of generating the weighted sum of a plurality of vectors by the component 27 may be the same as the method of generating the weighted sum of a plurality of vectors by the component 22. As described above, the difference vectors 201 to 20m respectively represent differences from an average of the short-term features extracted from the partial multivariate time-series data 171 to 17m. This means that differences from an average of the short-term features extracted from the source multivariate time-series data 152 are embedded in the intermediate vector 195.

The component 28 inputs thereto the difference vectors 201 to 20m from the component 26, and generates and outputs an intermediate vector 196. Specifically, the component 28 reorders the input difference vectors 201 to 20m according to the acquired time of the corresponding partial multivariate time-series data 171 to 17m. Then, the component 28 extracts features that depend on the sequence (order) of the difference vectors, from the reordered difference vectors 201 to 20m. As described above, in the difference vectors 201 to 20m, differences from an average of the short-term features according to the respective acquired time are embedded. Accordingly, the features extracted by the component 28 are features that appear as a gradual tendency in a long term of differences from an average of the short-term features, that is, long-term features. The component 28 also generates an intermediate vector 196 from the extracted long-term features. That is, the component 28 generates the intermediate vector 196 in which the extracted long-term features are embedded. The component 28 having the function as described above may be realized through learning of a neural network such as a recurrent neural network (RNN, LSTM, GRU, or the like), CNN, Transformer, or the like.

The component 24 inputs thereto the intermediate vectors 191, 192, 195, and 196 from the components 22, 23, 27, and 28. Then, the component 24 generates and outputs the feature vector 193 in which the intermediate vectors 191, 192, 195, and 196 are embedded. For example, the component 24 may generate a vector by connecting the intermediate vectors 191, 192, 195, and 196, as the feature vector 193. Alternatively, the component 24 may generate the sum of the intermediate vectors 191, 192, 195, and 196 or a weighted sum calculated by the same method as that used for the component 22, as the feature vector 193. The component 25 inputs thereto the feature vector 193 from the component 24, and outputs the scalar value 194 indicating the remaining useful life.

As described above, the model 153 of the present embodiment generates the feature vector 193 in which features (a type of short-term features) representing differences from an average of the short-term features respectively extracted from the partial multivariate time-series data constituting the multivariate time-series data, are further embedded. Moreover, the model 153 of the present embodiment generates the feature vector 193 in which features (a kind of long-term features) that appear as a gradual tendency in a long term of the short-term features representing differences from the average, is further embedded. Therefore, in the model 153 of the present embodiment, the types of the short-term features and long-term features that can be extracted from the multivariate time-series data are increased, as compared with the model 153 of the first example embodiment. As a result, in the present embodiment, it is possible to acquire features indicating the remaining useful life of the device that appear in the time-series data in various forms more reliably, and to improve the prediction accuracy of the remaining useful life.

As the method of dividing the multivariate time-series data 152 in the present embodiment, various types of methods may be considered as similar to the first example embodiment, and the method is not particularly limited. However, in the present embodiment, when the device 17 performs repeated operation, it is preferable to divide the time-series data for each cycle of the repeated operation. By dividing the multivariate time-series data 152 in this manner, the short-term features generated by the component 26 of the model 153 and embedded in the intermediate vector 195 by the component 27 serve as short-term features that represent differences from an average of the short-term features for each repeated operation of the device 17. Therefore, it is possible to acquire such short-term features as information indicating the remaining useful life of the device 17. Moreover, long-term features generated by the component 28 and embedded in the intermediate vector 196 serve as long-term features that appear as a gradual tendency in a long term of the short-term features representing differences from an average of the short-term features for each repetition of the device 17. Therefore, it is possible to acquire such long-term features as information indicating the remaining useful life of the device 17.

### Third Example Embodiment

As compared with the first example embodiment, the present embodiment is similar to the first example embodiment except for the configuration of the model 153.

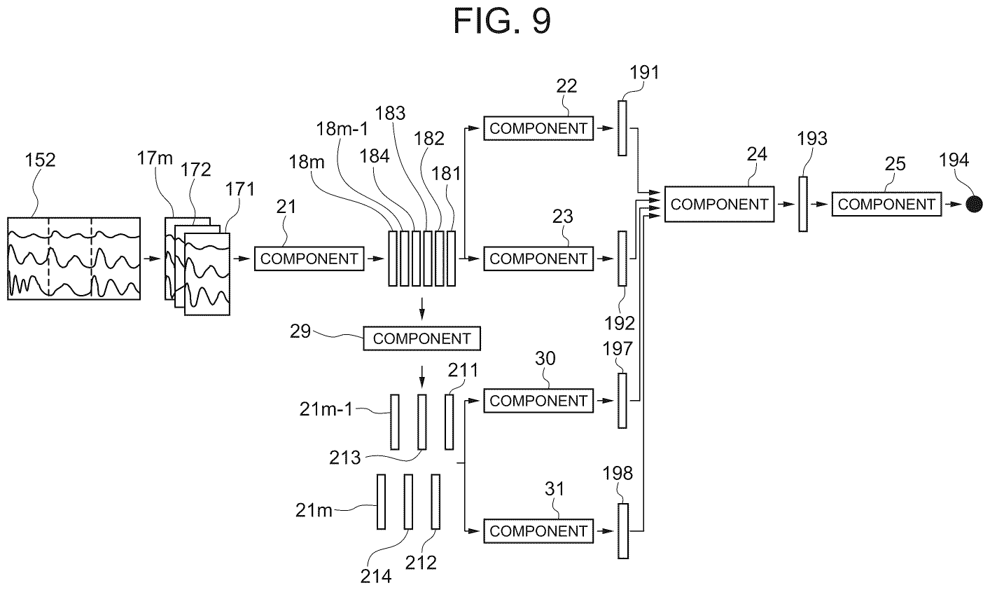

FIG. 9 is a configuration diagram illustrating an example of a model 153 used in the present embodiment. As compared with the model 153 illustrated in FIG. 4, the model 153 of this example is similar to the model 153 illustrated in FIG. 4 except that the model 153 of this example further includes components 29 to 31.

The component 29 inputs thereto the column vectors 181 to 18m from the component 21, and generates and outputs difference vectors 211 to 21m that correspond to the column vectors 181 to 18m one to one. Generation of the difference vectors are carried out as described below. First, the component 29 classifies the column vectors 181 to 18m into a group of the column vectors 181, 183, . . . , and 18m-1 in the odd-number places and a group of the column vectors 182, 184, . . . , and 18m in the even-number places when the column vectors 181 to 18m are reordered in the time order of the partial multivariate time-series data 171 to 17m. Then, for each group, the component 29 calculates an average vector of all column vectors belonging to the group. As described above, in the column vectors 181 to 18m, the short-term features extracted from the partial multivariate time-series data 171 to 17m are embedded. Accordingly, it can be said that the average vector of each group is an average of the short-term features of each group. Then, for each group, the component 29 calculates a difference between a column vector belonging to the group and the average vector, and generates a difference vector of each group. Accordingly, the component 29 generates difference vectors 211, 213, . . . , and 21m-1 representing differences between the column vectors belonging to the odd-number group and the average vector, and difference vectors 212, 214, . . . , and 21m representing differences between the column vectors belonging to the even-number group and the average vector.

The component 30 inputs thereto the difference vectors 211 to 21m of the odd-number group and the even-number group from the component 29, and generates and outputs an intermediate vector 197 in which all of the difference vectors are embedded. For example, the component 30 may generate a weighted sum of the difference vectors 211 to 21m as the intermediate vector 197. The method of generating the weighted sum of a plurality of vectors by the component 30 may be the same as the method of generating the weighted sum of a plurality of vectors by the component 22. As described above, the difference vectors in the odd-number places and in the even-number places represent differences from averages of the short-term features in the odd-number places and in the even-number places extracted from the partial multivariate time-series data 171 to 17m in the odd-number places and in the even number places. This means that in the intermediate vector 197, the features representing the differences from the averages of the short-term features in the odd-number places and the even-number places (these are also short-term features) are embedded.

The component 31 inputs thereto difference vectors of the respective groups from the component 29, and generates and outputs an intermediate vector 198. Specifically, the component 31 reorders the input difference vectors 211 to 21m according to the acquired time of the corresponding partial multivariate time-series data 171 to 17m for each group. Then, the component 31 extracts features that depend on the sequence (order) of the difference vectors for each group, from the reordered difference vectors. As described above, in the difference vectors of each group, difference vectors from an average of the short-term features of each group corresponding to the acquired time thereof are embedded. Accordingly, the features extracted by the component 31 are features that appear as a gradual tendency in a long term of the differences from an average of the short-term features of each group, that is, long-term features. The component 31 also generates an intermediate vector 198 from the extracted long-term features of each group. That is, the component 31 generates the intermediate vector 198 in which the extracted long-term features of each group are embedded. The component 31 having the function described above may be realized through learning of a neural network such as a recurrent neural network (RNN, LSTM, GRU, or the like), CNN, Transformer, or the like.

The component 24 inputs thereto the intermediate vectors 191, 192, 197, and 198 from the components 22, 23, 30, and 31. Then, the component 24 generates and outputs the feature vector 193 in which the intermediate vectors 191, 192, 197, and 198 are embedded. For example, the component 24 may generate a vector by connecting the intermediate vectors 191, 192, 197, and 198, as the feature vector 193. Alternatively, the component 24 may generate the sum of the intermediate vectors 191, 192, 197, and 198 or a weighted sum calculated by the same method as that used for the component 22, as the feature vector 193. The component 25 inputs thereto the feature vector 193 from the component 24, and outputs the scalar value 194 indicating the remaining useful life.

As described above, the model 153 of the present embodiment classifies the partial multivariate time-series data into an odd-number group and an even-number group, and for each group, generates the feature vector 193 in which features (a type of short-term features) representing differences from an average of the short-term features respectively extracted from the partial multivariate time-series data belonging to the group, are further embedded. Moreover, the model 153 of the present embodiment generates, for each group, the feature vector 193 in which features (a type of long-term features) that appear as a gradual tendency in a long term of the short-term features representing the differences from the average, is further embedded. Therefore, in the model 153 of the present embodiment, the types of the short-term features and long-term features that can be extracted from the multivariate time-series data are increased, as compared with the model 153 of the first example embodiment. As a result, in the present embodiment, it is possible to acquire information indicating the remaining useful life of a device that appears in various forms in the time-series data more reliably, and to improve the prediction accuracy of the remaining useful life.

As the method of dividing the multivariate time-series data 152 in the present embodiment, various types of methods may be considered as similar to the first example embodiment, and the method is not particularly limited. However, in the present embodiment, when the device 17 performs repeated operation, it is preferable to first divide the time-series data for each cycle of the repeated operation, and then divide the operation of one cycle into a first half portion and a second half portion. By dividing the multivariate time-series data 152 in this manner, the short-term features generated by the component 29 of the model 153 and embedded in the intermediate vector 197 by the component 30 serve as short-term features that represent differences from the averages of the short-term features in the first half portion and in the second half portion of each repeated operation of the device 17. Therefore, such short-term features can be acquired as information indicating the remaining useful life of the device 17. Moreover, long-term features that are generated by the component 31 and embedded in the intermediate vector 198 serve as long-term features that appear as a gradual tendency in a long term of the short-term features representing differences from the averages of the short-term features in the first half portion and the second half portion of each repetition of the device 17. Such long-term features can be acquired as information indicating the remaining useful life of the device 17.

While the column vectors 181 to 18m are classified into two groups in the above description, they may be classified into three or more groups. For example, when the one-cycle operation of the device 17 is configured of four steps namely a step 1, a step 2, a step 3, and a step 4, it is possible to divide the multivariate time-series data 152 obtained by the device 17 into partial multivariate time-series data that correspond to the respective steps one to one, and classify the column vectors 181 to 18m into four groups corresponding to the respective steps.

### Fourth Example Embodiment

In the present embodiment, the present invention is applied to a dual estimation model for performing RUL estimation described in Patent Literature 3 and Non-Patent Literature 1.

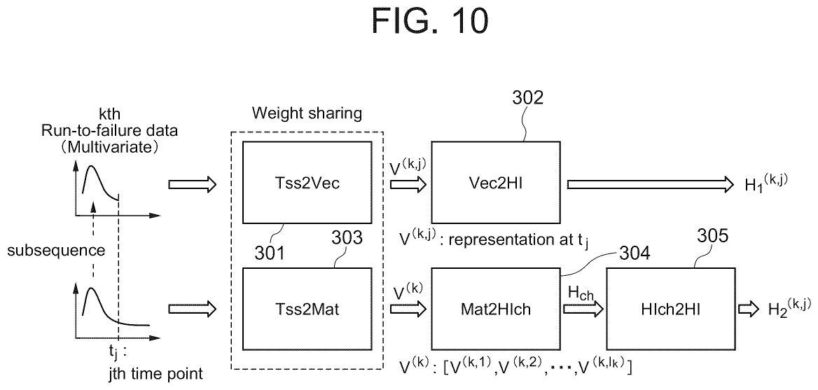

FIG. 10 is a block diagram illustrating a configuration of a dual estimation model to which the present invention is applied. The dual estimation model 300 includes five components 301 to 305. In the learning phase, all components 301 to 305 are used, and in the prediction phase, the component 301 and the component 302 are used. In Patent Literature 3 and Non-Patent Literature 1, the component 301 is referred to as Tss2Vec, the component 302 is referred to as Vec2HI, the component 303 is referred to as Tss2Mat, the component 304 is referred to as Mat2HIch, and the component 305 is referred to as HIch2HI.

It is assumed that X^{(k)} represents the k^{th} example from execution data up to K pieces of failures (run-to-failure data), X^{(k,j)} represents the j^{th} observation in the example, and X^{(k,jk)} represents observation at the failure. Here, j represents a time index of data up to occurrence of a failure, and a smaller value indicates an older record. IK represents a time-series length and a time index at the time of failure. X^{(k,lk)} represents a vector whose length is A. Here, A represents the number of attributes of a sensor or the like. A partial time-series of X^{(k}) may be x. It is assumed that x^{(k,j)} represents partial time-series of X^{(k)} that begins at the 1^{st} time index and ends at the j^{th} time index, v^{(k,j)} represents its feature expression, and V^{(k)}=[v^{(k,1)}, v^{(k,2)} . . . , v^{(k,jk)}] represents a feature expression of the entire X^{(k)}. The head of x^{(k,j)} may be the head of X^{(k)}, but it is not mandatory.

When x^{(k,j)} is input, the component 301 outputs its feature expression v^{(k,j)}, and the component 302 outputs a remaining useful life H₁^{(k,j)} at j on the basis of the v^{(k,j)}. When the k^{th} execution data X^{(k)} is input, the component 303 outputs V^{(k)}, and the component 304 transforms V^{(k)} into a change point H_{ch}^{(k)} of HI (health index). Finally, the component 305 outputs the remaining useful life H₂(^{k,j)} at j on the basis of H_{ch}^{(k)}.

The component 301 and the component 303 are the same except for the inputs thereto and outputs therefrom. The component 301 inputs thereto partial time-series x^{(k,j)}, and outputs a vector v^{(k,j)}. Th component 303 repeats the entire j processes, and connects all vectors to form a matrix. For example, the components 301 and 303 may be configured of the components 21 to 24 in FIG. 4. Alternatively, the components 301 and 303 may be configured of the components 21 to 24 and 26 to 28 in FIG. 8. Alternatively, the components 301 and 303 may be configured of the components 21 to 24 and 29 to 31 in FIG. 9. Moreover, the component 302 may be the same as the component 25 in FIG. 4.

When there is a large amount of data, the component 304 may be configured of any neural network that transforms a column vector group into a scalar value. When the amount of data is small, it is desirable that the component 304 uses a weighted sum of the remaining useful life using an attention mechanism for example. The component 305 may be configured of a function of calculating the remaining useful life H₂ from correct values of the change point H_{ch} of health index (estimated by the component 304) and the remaining useful life H₁. For example, the component 305 may be configured of Leaky Truncated RUL Function or Piece-wise RUL function.

In the learning phase, the dual estimation model 300 inputs thereto data X^{(k)} up to a failure and examples of the partial time-series x^{(k,j)} thereof as inputs at once, and outputs two RUL estimations H₁^{(k,j)} and H₂^{(k,j)}. Then, in the learning phase, under a condition that the change point of the health index is increased as much as possible, a weight such as a parameter or the like of each component of the dual estimation model 300 is adjusted so as to minimize the difference between the two RUL estimations H₁(k,j) and H₂^{(k,j)}. In the prediction phase, the dual estimation model 300 inputs thereto multivariate time-series data for prediction, and outputs the remaining useful life at the end of the multivariate time-series data.

### Fifth Example Embodiment

In the example embodiments described above, an information processing device predicts the remaining useful life of the device 17 on the basis of time-series data of measurement values of a sensor acquired from the device 17. However, the information processing device may predict the remaining useful life of the device on the basis of history of events (time-series data) such as failure, maintenance, and the like, instead of or in addition to the time-series data of measurement values of a sensor In that case, as illustrated in FIG. 1 for example, the device 17 includes a storage unit 19 that stores therein time-series data of events that occurred in the device 17. The type and the number of events are not limited. For example, events may be related to failure, or may be related to maintenance. For example, time-series data of a failure event includes event type, date and time when the failure occurred, date and time of recovery, and the like. Further, time-series data of a maintenance event includes event type, date and time when the maintenance was performed, the content of maintenance, and the like. The device I/F unit 11 is configured to read time-series data of one or more events from the storage unit 19, and transmit it to the arithmetic processing unit 16.

### Sixth Example Embodiment

In the example embodiments describe above, the remaining useful life of a device is predicted. However, the present invention may be applied to abnormality detection of a device that is two-class classification, and failure diagnosis and deterioration condition estimation (discrete remaining useful life estimation) that is multiclass classification. In that case, as one method of execution, is it considerable to set the number of the components 25 (corresponding to nodes at the last layer) to be the same as the number of classes, and learn a model so as to minimize the cross entropy as an objective function (loss function). Further, as another method of execution, a feature vector may be discriminated by embedding or k-NN in the framework of distant learning, instead of the component 25 having the configuration as described above. In the case of discrete remaining useful life estimation, it is possible to output an average value of k-NN or a weighted average value using kernel.

### Seventh Example Embodiment

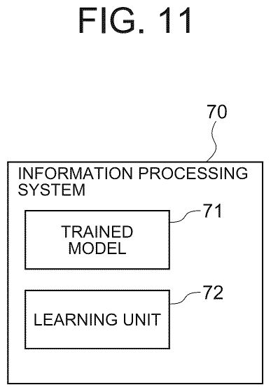

FIG. 11 is a block diagram of an information processing system according to a seventh example embodiment of the present invention. Referring to FIG. 11, an information processing device 70 according to the present embodiment includes a learning unit 72 that generates a trained model 71 that predicts a condition of a device from time-series data acquired from the device.

The trained model 71 includes a first component that extracts features that depend on the sequence from a plurality of pieces of partial time-series data obtained by dividing the time-series data along the time axis, and generates a plurality of first vectors in which the extracted features are embedded and which correspond to the plurality of partial time-series data one to one. The trained model 71 also includes a second component that generates a second vector in which a plurality of the first vectors are embedded. Further, the trained model 71 includes a third component that extracts features that depend on the sequence from the first vectors, and generate a third vector in which the extracted features are embedded. The trained model 71 also includes a fourth component that generates a fourth vector in which the second vector and the third vector are embedded. The trained model 71 also includes a fifth component that transforms the fourth vector into a first value that represents a condition of the device.

The information processing system 70 configured as described above operates as described below. That is, the learning unit 72 generates the trained model 71 that predicts a condition of a device from time-series data acquired from the device. In this generation, the learning unit 72 allows the trained model 71 to extract features that depend on the sequence from respective pieces of the partial time-series data obtained by dividing the time-series data along the time axis, generate a plurality of first vectors in which the extracted features are embedded and which correspond to the pieces of the partial time-series data one to one, generate a second vector in which the first vectors are embedded, extract features that depend on the sequence from the first vectors, generate a third vector in which the extracted features are embedded, generate a fourth vector in which the second vector and the third vector are embedded, and transform the fourth vector into a first value representing a condition of the device.

According to the information processing system 70 that is configured and operates as described above, it is possible to acquire both short-term features and long-term features indicating a condition such as remaining useful life of the device that appears in various forms in the time-series data acquired from the device. Therefore, the condition of the device can be predicted with high accuracy. Moreover, there are routes for effective learning according to the short-term features and the long-term features. Therefore, learning can progress efficiently, and the trained model 71 can efficiently acquire features effective for prediction of a condition such as remaining useful life. As a result, the prediction accuracy of a condition of the device can be improved.

### Eighth Example Embodiment

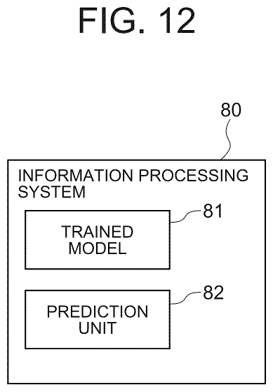

FIG. 12 is a block diagram of an information processing system according to an eighth example embodiment of the present invention. Referring to FIG. 12, an information processing device 80 according to the present embodiment includes a prediction unit 82 that predicts a condition of a device from time-series data acquired from the device, by using a trained model 81.

The trained model 81 includes a first component that extracts features that depend on the sequence from a plurality of pieces of partial time-series data obtained by dividing the time-series data along the time axis, and generates a plurality of first vectors in which the short-term features are embedded and which correspond to the plurality of partial time-series data one to one. The trained model 81 also includes a second component that generates a second vector in which the first vectors are embedded. Further, the trained model 81 includes a third component that extracts features that depend on the sequence from the first vectors, and generate a third vector in which the extracted features are embedded. The trained model 81 also includes a fourth component that generates a fourth vector in which the second vector and the third vector are embedded. The trained model 81 also includes a fifth component that transforms the fourth vector into a first value that represents a condition of the device.

The information processing system 80 configured as described above operates as described below. That is, the prediction unit 82 predicts a condition of a device from time-series data acquired from the device, by using the trained model 81. In the prediction, the prediction unit 82 allows the trained model 81 to extract features that depend on the sequence from respective pieces of partial time-series data obtained by dividing the time-series data along the time axis, generate a plurality of first vectors in which the features are embedded and which correspond to the pieces of the partial time-series data one to one, generate a second vector in which the first vectors are embedded, extract features that depend on the sequence from the first vectors, generate a third vector in which the extracted features are embedded, generate a fourth vector in which the second vector and the third vector are embedded, and transform the fourth vector into a first value representing a condition of the device.

According to the information processing system 80 that is configured and operates as described above, it is possible to acquire both short-term features and long-term features indicating a condition such as remaining useful life of the device that appear sin various forms in the time-series data acquired from the device. Therefore, the condition of the device can be predicted with high accuracy. Moreover, there are routes for effective learning according to the short-term features and the long-term features. Therefore, learning can progress efficiently, and the trained model 81 can efficiently acquire features effective for prediction of a condition such as remaining useful life. As a result, the prediction accuracy of a condition of the device can be improved.

While the present invention has been described with reference to the example embodiments described above, the present invention is not limited to the above-described embodiments. The form and details of the present invention can be changed within the scope of the present invention in various manners that can be understood by those skilled in the art.

### INDUSTRIAL APPLICABILITY

The present invention is applicable to the entire fields of predicting a condition such as remaining useful life of various types of devices such as machine tools, chemical plants, IT devices, and semiconductor devices, on the basis of time-series data of measurement values of a sensor acquired from a device or time-series data of events recorded on the device, and performing predictive maintenance according to the prediction result.

The whole or part of the example embodiments disclosed above can be described as, but not limited to, the following supplementary notes.

### Supplementary Note 1

An information processing system comprising
a learning unit configured to generate a trained model that predicts a condition of a device from time-series data acquired from the device, wherein
the trained model includes:
a first component that extracts features that depend on sequence from a plurality of pieces of partial time-series data obtained by dividing the time-series data along a time axis, and generates a plurality of first vectors in which the extracted features are embedded, each of the first vectors corresponding to each of the pieces of the partial time-series data one to one;
a second component that generates a second vector in which the first vectors are embedded;
a third component that extracts features that depend on sequence from the first vectors, and generates a third vector in which the extracted features are embedded;
a fourth component that generates a fourth vector in which the second vector and the third vector are embedded; and
a fifth component that transforms the fourth vector into a first value that represents a condition of the device.

### Supplementary Note 2

The information processing system according to supplementary note 1, wherein
the trained model further includes:
a sixth component that generates a plurality of fifth vectors each obtained by calculating, for each of the first vectors, a difference between each of the first vectors and an average vector of the first vectors;
a seventh component that generates a sixth vector in which the fifth vectors are embedded; and
an eighth component that extracts features that depend on sequence from the fifth vectors, and generates a seventh vector in which the extracted features are embedded, and
the fourth component generates the fourth vector in which the sixth vector and the seventh vector are further embedded.

### Supplementary Note 3

The information processing system according to supplementary note 1, wherein
the trained model further includes:
a sixth component that divides the first vectors into a plurality of groups, and for each of the groups, generates a plurality of fifth vectors each obtained by calculating a difference between each of the first vectors belonging to the group and an average vector of the first vectors belonging to the group;
a seventh component that generates a sixth vector in which the fifth vectors are embedded; and
an eighth component that, for each of the groups, extracts features that depend on sequence from the fifth vectors belonging to the group, and generates a seventh vector in which the extracted features are embedded, and
the fourth component generates the fourth vector in which the sixth vector and the seventh vector are further embedded.

### Supplementary Note 4

The information processing system according to any of supplementary notes 1 to 3, wherein
the trained model further includes:
a ninth component that includes the first component, the second component, the third component, and the fourth component, the ninth component inputting, into the ninth component, a plurality of pieces of partial time-series data constituting time-series data representing execution data up to an observed condition, and generating and outputting a plurality of the fourth vectors corresponding to the input pieces of time-series data one to one;
a tenth component that inputs, into the tenth component, the fourth vectors output from the ninth component, and calculates a change point of a health index; and
an eleventh component that generates and outputs a second value serving as a teacher of the first value, on a basis of the change point of the health index.

### Supplementary Note 5

The information processing system according to any of supplementary notes 1 to 4, wherein
the first value is a value representing remaining useful life of the device.

### Supplementary Note 6

The information processing system according to any of supplementary notes 1 to 5, wherein
the first value is a value representing presence or absence of abnormality in the device, presence or absence of a failure, or a deterioration state.

### Supplementary Note 7

The information processing system according to any of supplementary notes 1 to 6, further comprising
an output unit that issues an alarm in response to the first value.

### Supplementary Note 8

The information processing system according to any of supplementary notes 1 to 7, further comprising
an output unit that executes a coping method defined in advance with respect to the device, in response to the first value.

### Supplementary Note 9

An information processing system comprising
a prediction unit configured to predict a condition of a device from time-series data acquired from the device by using a trained model, wherein
the trained model includes:
a first component that extracts features that depend on sequence from a plurality of pieces of partial time-series data obtained by dividing the time-series data along a time axis, and generates a plurality of first vectors in which the extracted features are embedded, each of the first vectors corresponding to each of the pieces of the partial time-series data one to one;
a second component that generates a second vector in which the first vectors are embedded;
a third component that extracts features that depend on sequence from the first vectors, and generates a third vector in which the extracted features are embedded;
a fourth component that generates a fourth vector in which the second vector and the third vector are embedded; and
a fifth component that transforms the fourth vector into a first value that represents a condition of the device.

### Supplementary Note 10

An information processing method comprising
generating a trained model that predicts a condition of a device from time-series data acquired from the device, wherein
the generating includes allowing the trained model to:
extract features that depend on sequence from a plurality of pieces of partial time-series data obtained by dividing the time-series data along a time axis;
generate a plurality of first vectors in which the extracted features are embedded, each of the first vectors corresponding to each of the pieces of the partial time-series data one to one;
generate a second vector in which the first vectors are embedded;
extract features that depend on sequence from the first vectors;
generate a third vector in which the extracted features are embedded;
generate a fourth vector in which the second vector and the third vector are embedded; and
transform the fourth vector into a first value that represents a condition of the device.

### Supplementary Note 11

An information processing method comprising
predicting a condition of a device from time-series data acquired from the device by using a trained model, wherein
the predicting includes allowing the trained model to:
extract features that depend on sequence from a plurality of pieces of partial time-series data obtained by dividing the time-series data along a time axis;
generate a plurality of first vectors in which the extracted features are embedded, each of the first vectors corresponding to each of the pieces of the partial time-series data one to one;
generate a second vector in which the first vectors are embedded;
extract features that depend on sequence from the first vectors;
generate a third vector in which the extracted features are embedded;
generate a fourth vector in which the second vector and the third vector are embedded; and
transform the fourth vector into a first value that represents a condition of the device.

### Supplementary Note 12

A computer-readable medium storing thereon a program for causing a computer to execute processing to generate a trained model that predicts a condition of a device from time-series data acquired from the device, wherein
the generating includes allowing the trained model to:
extract features that depend on sequence from a plurality of pieces of partial time-series data obtained by dividing the time-series data along a time axis;
generate a plurality of first vectors in which the extracted features are embedded, each of the first vectors corresponding to each of the pieces of the partial time-series data one to one;
generate a second vector in which the first vectors are embedded;
extract features that depend on sequence from the first vectors;
generate a third vector in which the extracted features are embedded;
generate a fourth vector in which the second vector and the third vector are embedded; and
transform the fourth vector into a first value that represents a condition of the device.

### Supplementary Note 13

A computer-readable medium storing thereon a program for causing a computer to execute processing to predict a condition of a device from time-series data acquired from the device by using a trained model, wherein
the predicting includes allowing the trained model to:
extract features that depend on sequence from a plurality of pieces of partial time-series data obtained by dividing the time-series data along a time axis;
generate a plurality of first vectors in which the extracted features are embedded, each of the first vectors corresponding to each of the pieces of the partial time-series data one to one;
generate a second vector in which the first vectors are embedded;
extract features that depend on sequence from the first vectors;
generate a third vector in which the extracted features are embedded;
generate a fourth vector in which the second vector and the third vector are embedded; and
transform the fourth vector into a first value that represents a condition of the device.

### REFERENCE SIGNS LIST

10 information processing device
11 device I/F unit
12 communication I/F unit
13 operation input unit
14 screen display unit
15 storage unit
16 arithmetic processing unit
17 device
18 sensor
19 storage unit
21-25 component
70 information processing system
71 trained model
72 learning unit
80 information processing system
81 trained model
82 prediction unit
151 program
152-1 multivariate time-series data for learning
152-2 multivariate time-series data for prediction
153-1 untrained model
153-2 trained model
154 prediction result information
161 acquisition unit
162 learning unit
163 prediction unit
164 output unit
171-17m partial multivariate time-series data
181-18m column vector
191, 192, 195, 196, 197, 198 intermediate vector
193 feature vector
194 scalar value
201-20m difference vector
211-21m difference vector
300 dual estimation model
301-305 component

What is claimed is:

1. An information processing system comprising:
a memory containing program instructions; and
a processor coupled to the memory, wherein the processor is configured to execute the program instructions to:
generate a trained model that predicts a condition of a device from time-series data acquired from the device, and
the trained model includes:
a first component that extracts features that depend on sequence from a plurality of pieces of partial time-series data obtained by dividing the time-series data along a time axis, and generates a plurality of first vectors in which the extracted features are embedded, each of the first vectors corresponding to each of the pieces of the partial time-series data one to one;
a second component that generates a second vector in which the first vectors are embedded;
a third component that extracts features that depend on sequence from the first vectors, and generates a third vector in which the extracted features are embedded;
a fourth component that generates a fourth vector in which the second vector and the third vector are embedded; and
a fifth component that transforms the fourth vector into a first value that represents a condition of the device.

2. The information processing system according to claim 1, wherein
the trained model further includes:
a sixth component that generates a plurality of fifth vectors each obtained by calculating, for each of the first vectors, a difference between each of the first vectors and an average vector of the first vectors;
a seventh component that generates a sixth vector in which the fifth vectors are embedded; and
an eighth component that extracts features that depend on sequence from the fifth vectors, and generates a seventh vector in which the extracted features are embedded, and
the fourth component generates the fourth vector in which the sixth vector and the seventh vector are further embedded.

3. The information processing system according to claim 1, wherein
the trained model further includes:
a sixth component that divides the first vectors into a plurality of groups, and for each of the groups, generates a plurality of fifth vectors each obtained by calculating a difference between each of the first vectors belonging to the group and an average vector of the first vectors belonging to the group;
a seventh component that generates a sixth vector in which the fifth vectors are embedded; and
an eighth component that, for each of the groups, extracts features that depend on sequence from the fifth vectors belonging to the group, and generates a seventh vector in which the extracted features are embedded, and
the fourth component generates the fourth vector in which the sixth vector and the seventh vector are further embedded.

4. The information processing system according to claim 1, wherein
the trained model further includes:
a ninth component that includes the first component, the second component, the third component, and the fourth component, the ninth component inputting, into the ninth component, a plurality of pieces of partial time-series data constituting time-series data representing execution data up to an observed condition, and generating and outputting a plurality of the fourth vectors corresponding to the input pieces of time-series data one to one;
a tenth component that inputs, into the tenth component, the fourth vectors output from the ninth component, and calculates a change point of a health index; and
an eleventh component that generates and outputs a second value serving as a teacher of the first value, on a basis of the change point of the health index.

5. The information processing system according to claim 1, wherein
the first value is a value representing remaining useful life of the device.

6. The information processing system according to claim 1, wherein
the first value is a value representing presence or absence of abnormality in the device, presence or absence of a failure, or a deterioration state.

7. The information processing system according to claim 1, wherein the processor is further configured to execute the instructions to
issue an alarm in response to the first value.

8. The information processing system according to claim 1, wherein the processor is further configured to execute the instructions to
execute a coping method defined in advance with respect to the device, in response to the first value.

9-10. (canceled)

11. An information processing method comprising
predicting a condition of a device from time-series data acquired from the device by using a trained model, wherein
the predicting includes allowing the trained model to:
extract features that depend on sequence from a plurality of pieces of partial time-series data obtained by dividing the time-series data along a time axis;
generate a plurality of first vectors in which the extracted features are embedded, each of the first vectors corresponding to each of the pieces of the partial time-series data one to one;
generate a second vector in which the first vectors are embedded;
extract features that depend on sequence from the first vectors;
generate a third vector in which the extracted features are embedded;
generate a fourth vector in which the second vector and the third vector are embedded; and
transform the fourth vector into a first value that represents a condition of the device.

12. (canceled)

13. A non-transitory computer-readable medium storing thereon a program comprising instructions for causing a computer to execute processing to predict a condition of a device from time-series data acquired from the device by using a trained model, wherein
the predicting includes allowing the trained model to:
extract features that depend on sequence from a plurality of pieces of partial time-series data obtained by dividing the time-series data along a time axis;
generate a plurality of first vectors in which the extracted features are embedded, each of the first vectors corresponding to each of the pieces of the partial time-series data one to one;
generate a second vector in which the first vectors are embedded;
extract features that depend on sequence from the first vectors;
generate a third vector in which the extracted features are embedded;
generate a fourth vector in which the second vector and the third vector are embedded; and
transform the fourth vector into a first value that represents a condition of the device.
